(19) United States
(12) Patent Application Publication
(10) Pub. No.: US 2026/0311439 A1
(43) Pub. Date: Oct. 8, 2026

(54) SYSTEM AND METHOD FOR DEPTH AND COLOR FUSION FOR PRECISE FACIAL LANDMARK DETECTION

(71) Applicant: XRPro, LLC, Boulder, CO (US)

(72) Inventors: Kazi Miftahul Hoque, Jashore (BD); Paulo E. Xavier da Silveira, Boulder, CO (US); Dmitrii Aleksandrovich Gladyshev, Longmont, CO (US); Anton Aleksandrovich Tokar, Longmont, CO (US); Isobel Jane Mulligan, Niwot, CO (US)

(21) Appl. No.: 19/169,188

(22) Filed: Apr. 3, 2025

Related U.S. Application Data
(60) Provisional application No. 63/574,396, filed on Apr. 4, 2024.

(51) Int. Cl. G06T 19/20; G06T 7/50; G06T 7/73; G06T 15/04; G06T 17/20

(52) U.S. Cl. CPC G06T 19/20; G06T 7/50; G06T 7/74; G06T 15/04; G06T 17/20; G06T 2207/30201; G06T 2219/2004

(57) ABSTRACT

A system for localizing anatomical landmarks with respect to a three-dimensional mesh of a feature of a body. For example, the system may be configured to precisely localize facial landmarks with respect to a three-dimensional mesh of a head of a user. The system may then utilize the localized facial landmarks for production of custom headgear.

### CROSS-REFERENCE TO RELATED APPLICATION

This application claims priority to U.S. Provisional Application No. 63/574,396 filed on Apr. 4, 2024 and entitled “Depth and Color Fusion for Precise Facial Landmarks Detection Using Three-Dimensional Sensor Data,” which is incorporated herein by reference in its entirety.

### BACKGROUND

Today, facial landmark detection conventionally relies on two-dimensional (2D) image data analysis techniques. However, while 2D image analysis provides computational efficiencies, a key disadvantage of 2D landmark detection is a lack of precise distance information among and between the landmarks. This limitation of conventional systems renders these methods unsuitable for applications such as medical applications, custom head mounts, custom glasses, custom helmets, therapeutic helmets, and the like. Accordingly, medical experts and clinicians require a system for scanning patient heads and faces and precisely positioning landmarks with respect to a three-dimensional (3D) model of the patient head.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical components or features.

FIG. 1 is an example block diagram of a system for generating three-dimensional meshes or models of a feature of an individual with precise anatomical landmarks according to some implementations.

FIG. 2 is an example block diagram of an architecture for the system for generating three-dimensional meshes or models of a feature of an individual with precise anatomical landmarks according to some implementations.

FIG. 3 is an example process flow associated with generating a three-dimensional model or mesh with precise anatomical landmarks associated with multiple surfaces or sides of the three-dimensional model according to some implementations.

FIG. 4 is an example process flow associated with determining if particular fames of image data and depth data are integrated into the 3D mesh or model or unitized to assist with localizing anatomical landmarks with respect to the 3D mesh or model according to some implementations.

FIG. 5 is an example process flow associated with localizing anatomical landmarks with respect to the 3D mesh or model according to some implementations.

FIG. 6 is another example process flow associated with localizing anatomical landmarks with respect to the 3D mesh or model according to some implementations.

FIG. 7 is an example process flow associated with aligning a three-dimensional mesh or model with a vertical and horizontal axis according to some implementations.

FIG. 8 is an example process flow associated with localizing anatomical landmarks with respect to the 3D mesh or model according to some implementations.

FIG. 9 is an example block diagram of an architecture for user equipment associated with generating multi-modal volumetric data according to some implementations.

FIG. 10 is an example block diagram of an architecture for a cloud-based anatomical data processing system associated with generating multi-modal volumetric data according to some implementations.

FIG. 11 is an example pictorial diagram of a three-dimensional mesh or model of a face or head of a user indicating various anatomical landmarks that may be determined based on the systems and methods discussed above with respect to FIGS. 1-10 according to some implementations.

FIG. 12 is an example pictorial diagram the anatomical landmarks of FIG. 11 projected onto three-dimensional mesh or model of a face or head of a user according to some implementations.

FIG. 13 is another example pictorial diagram of a three-dimensional mesh or model of an ear of a user indicating various anatomical landmarks that may be determined based on the systems and methods discussed above with respect to FIGS. 1-10 according to some implementations.

FIG. 14 is an example pictorial diagram of additional anatomical landmarks and/or measurements useful for manufacturing of custom headgear projected onto three-dimensional mesh or model of a face or head of a user according to some implementations.

FIG. 15 is another example pictorial diagram of additional anatomical landmarks and/or measurements useful for manufacturing of custom headgear projected onto three-dimensional mesh or model of a face or head of a user according to some implementations.

### DETAILED DESCRIPTION

Discussed herein are systems and architecture for generating multi-modal volumetric three-dimensional (3D) models (e.g., meshes, reconstruction, maps, and the like) of features (e.g., organs, limbs, epidermis, regions, characteristics, and the like) of a human body for use in medical diagnostics, monitoring (e.g., continuous, periodic, and the like), custom product manufacturing, and the like. In some cases, the systems and architectures, discussed herein, may be applicable to fields of 3D sensing of physical landmarks and/or parameters in 3D volumetric objects. More specifically to the field of sensing biological (unidimensional or multi-dimensional) landmarks and parameters associated with a face or head of a human for medical applications and customized product manufacturing.

For example, conventional systems for facial landmark detection primarily rely on two-dimensional (2D) image data analysis, offering advantages such as computational efficiency and simplicity. However, a key disadvantage of 2D landmark detection is the lack of precise distance information among and between the facial landmarks. This limitation of the conventional systems renders these methods unsuitable for applications including but not limited to custom head mounts, custom glasses, custom helmets, therapeutic helmets, and the like. That is, these conventional methods are unsuitable for applications that require accurate and precise user and/or patient measurements. However, the system and methods discussed herein may provide precise facial landmark positions, distance data, and measurements to achieving a precise fit and optimal comfort with respect to custom headgear thereby improving patient outcomes for medical applications.

In light of the above disadvantage, the system and methods discussed herein address a need for precise measurements in industries associated with custom medical head mounts, custom headwear, custom eyewear, and the like by leveraging 3D depth sensing and color image fusion to generate a 3D mesh obtained from a 3D scan that is a precise replica of the scanned face and head. In some cases, by incorporating depth data, the systems and methods overcome the current limitations of conventional 2D landmark detection, enabling the system discussed herein to more accurately identify the 3D location corresponding to each of the anatomic landmarks and to more accurately measure the distances between the detected anatomic landmarks.

In some cases, the systems and methods utilize a 3D sensor that captures depth data and 2D color image data, along with the color camera pose data (e.g., simultaneous location and mapping (SLAM) data, six degrees of freedom data, and/or the like). In some cases, the system may initially detect 2D landmarks based at least in part on the 2D color image data. The 2D landmarks are then projected onto a depth image associated with the depth data, such that the system may locate or position each landmark accurately on a 3D mesh representing the feature (e.g., head and face) of the user or patient. Additionally, the system may make adjustments to the 3D mesh, including positional adjustments, to further refine the accuracy of each of the detected facial landmarks. Accordingly, by combining the depth data and color image data with the 3D mesh, precise localization of each landmarks may be obtained.

In some cases, the detection of the landmarks (e.g., facial landmarks) may be divided into two parts. The first part may include capturing the depth data and the color image data and the second part may include the landmarks detection. The first part takes place when the object is being scanned. The system (such as user equipment or user device with hosted application) has a method and processes to capture color image data frames, depth frames, camera poses, and other related information associated with a scan session and store the captured frames and poses to a file or other location.

In some examples, a data capture device may be utilized to capture a small number of color frames (such as 2D color frames), respective depth frames (e.g., corresponding depth data), and camera poses (e.g., the color camera or sensor pose and the depth camera or sensor pose). For example, an angular difference between the two camera poses associated with two subsequent frames may be utilized while scanning to determine if the subsequent frame data is stored. For instance, if the angular difference between the camera pose of two frames is greater than or equal to a threshold difference, then frames and related data is captured and stored. In this manner, the system captures several frames instead of all frames associated with a scanning session (e.g., fewer frames are stored and captured, thereby reducing total data captured and subsequently processed).

In some examples, once the 2D color image data and the depth data are captured and stored, the system may filter the stored data to detect head poses associated with the capture session(s). For example, the system may determine a frontal profile pose and two side profile poses (e.g., a right and left) of the feature (e.g., the face of the user or patient) from the color frames and utilize the three representative frames for landmark detection and localization with respect to the 3D mesh of the feature (e.g., the face of the user or patient).

In some cases, the system may incorporate cloud-based resources and processing (e.g., such as for aggregation, filtering, data integration into one or more 3D volumetric models or meshes, model generation, application of one or more machine learning models, and the like). For example, the landmark detection or localization with respect to the 3D volumetric mesh may be processed and/or generated via cloud based services, systems, and/or processing resources. In some instances, the cloud-based services may include, among other elements, one or more servers in communication with one or more user equipment or devices over one or more networks.

In some case, as discussed herein, cloud-based processing may consist of multiple servers, available full-time and on demand, making their services substantially ubiquitous, constantly available, on demand and easily accessible (e.g., additional servers may be quickly activated in times of peak demand). Also, servers may consist of multiple computers in large service centers, using different operating systems, benefiting from lower-cost centralized utilities and services, and from expandable infrastructure, such as multiple parallel central processing units (CPUs), graphic processing units (GPUs), arithmetic logic units (ALUs), tensor processing units (TPUs) and quantum processing units (QPUs), to name a few. In general, cloud-servers may also be referred to as backend-servers or simply backend.

In some implementations, the cloud-based system discussed herein may include data pre-processing, use of one or more machine learning models that are trained on depth data, image data, 3D meshes and/or the like associated with anatomy of individuals having various conditions, symptoms, states of health, age, genders, cultural backgrounds, and the like. In some cases, the one or more machine learning models may also be trained to assist in diagnosing conditions and symptoms, generating 3D CAD files for products based on the detected landmarks, and/or the like with respect to various features and/or body parts (including faces) and individuals having a wide variety of features, body types, lifestyles (e.g., diet, exercise, work conditions, and the like), cultures, demographics (e.g., age, gender, and the like), such as those classified and identified by one or more other machine learning models (including, but not limited to, feet in various stages of load bearing and having various types and conditions of arches), determining health status, recommending patient specific treatments or therapies and the like.

As described herein, the machine learning models may be generated using various machine learning techniques. For example, the models may be generated using one or more neural network(s). A neural network may be a biologically inspired algorithm or technique which passes input data (e.g., image and sensor data captured by the user equipment or devices) through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from the captured sensor and/or image data. In some cases, the neural network may be a trained network architecture that is end-to-end. In one example, the machine learning models may include segmenting and/or classifying extracted deep convolutional features of the sensor and/or image data into semantic data. In some cases, appropriate truth outputs of the model in the form of semantic per-pixel classifications (e.g., vehicle identifier, container identifier, driver identifier, and the like).

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions, color analyzing or processing techniques and/or a combination thereof.

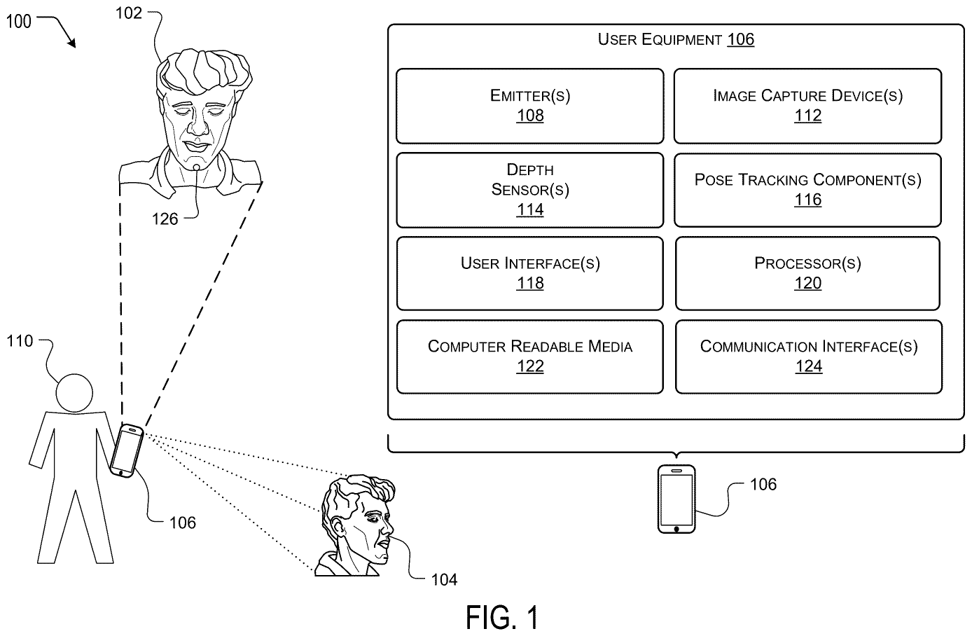

FIG. 1 is an example block diagram of a system 100 for generating three-dimensional meshes or models 102 of a feature 104 of an individual 110 with precise anatomical landmarks, such as landmark 126 according to some implementations. In the current example, the system 100 may include user equipment or scanning device 106 configured to capture depth data and 2D color image data of the feature 104 (e.g., the face or head of the individual 110) and to generate the 3D volumetric model or mesh 102 representing the feature 104. In the current example, the 3D volumetric model or mesh 102 is illustrated including a landmark 126, however, it should be understood that the 3D volumetric model or mesh 102 may be configured to include any number of anatomical landmarks 126 associated with the feature 104 (e.g., the face or head in the current example).

In some examples, the anatomical landmarks 126 may include, but are not limited to, the nasion, each pupil (e.g., a center of each pupil), the pronasale (e.g., nose tip), the subnasale, the labiale superius, the stomion, the labiale inferius, the gnathion (e.g., chin), the endocanthion, the exocanthion, the alare, the subalare, the crista philtra, each chelion, each otobasion superioris, each concha superioris, each tragus superioris, each intertragic incisure, each otobasion inferioris, each helix basal border, each crus helix, and the like. In some examples, the anatomical landmarks 126 may also include semi-landmarks, such as the eye corner, positioned along the edge of the exterior of the ear, and the like discussed in more detail below.

In the current example, the user equipment 106 may include one or more emitters 108 for outputting signals (such as particular types of light, waves, radiation, and the like) usable for determining depth while the individual 110 is scanning the feature 104 (e.g., the head or face).

The user equipment 106 may also include both image capture devices 112 and/or depth sensors 114. For example, the user equipment 102 may scan both image data (such as 2D color image data or red-green-blue data of the feature 104) together with depth data generated by the sensor 114 based at least in part on the output of the emitters 108. In some cases, the system may include additional sensors to generate other types of data, such as temperature data, microbial loads, and/or the like. In some cases, the image capture devices 112 and the sensors 114 may be combined, such as via the same device or package. In some cases, the image capture devices 112 and the sensors 114 may include one or more of devices configured to capture color data, infrared data, LIDAR data, radar data, impedance data, electric field data, photoplethysmography data, radio wave data, radiation data, audio data, stereoscopic data, magnetic data, contact data, depth data, temperature data, ultraviolet data, motion data, a combination thereof, and/or the like.

The user equipment 106 may also be configured to include pose tracking components 116 configured to determine orientation data and/or pose data with respect to the device 110. For example, the tracking components 116 may determine a pose associated with the image capture devices 112 and/or the depth sensor 114 while the individual 110 is scanning or capturing the image data and/or the depth data of the feature 104 (e.g., the face or head). For example, the pose tracking components 116 may be configured to generate a six-degree of freedom (6DOF) pose of the capture device 110, the image capture device 112, and/or the depth sensor 114 while the device is scanning the feature 104. In some cases, pose tracking components 116 may include one or more measurement units to determine the orientation data of the device 110 (e.g., acceleration, angular momentum, pitch, roll, yaw, etc. of the device 110). The measurement units may include one or more inertial measurement units (IMUs), one or more accelerometers, one or more gyroscopes, one or more magnetometers, and/or one or more pressure sensors, as well as other sensors. In one particular example, the measurement units may include three accelerometers placed orthogonal to each other, three rate gyroscopes placed orthogonal to each other, three magnetometers placed orthogonal to each other, and a barometric pressure sensor.

The user equipment 106 may also include one or more user interfaces 116. The user interfaces 118 may include input interfaces (e.g., mouse or keyboard) or output interfaces (e.g., a display). In some cases, the user interfaces 118 may include a virtual environment display or a traditional two-dimensional display, such as a liquid crystal display or a light emitting diode display. The user interfaces 118 may also include one or more input components for receiving feedback from the user. In some cases, the input components may include tactile input components, audio input components, or other natural language processing components. In one specific example, the user interfaces 118 may be a combined input and output, such as a touch enabled display for viewing and interacting with the 3D volumetric model or mesh 102 (and any identified and/or localized anatomical landmarks 126), performing a scan, and/or the like.

The user equipment 106 (e.g., a tablet, smartphone, computer, and/or the like) also includes processors 120, one or more computer-readable media 122, and/or communication interfaces 124, as discussed in more detail below. For example, each of the processors 120 may itself comprise one or more processors or processing cores. The computer-readable media 122 may include volatile media (such as random access memory (RAM)) and/or nonvolatile media (such as read only memory (ROM), Flash memory, optical disks, magnetic disks, and so forth). The computer-readable media 122 may include fixed media (e.g., RAM, ROM, a fixed hard drive, and so on) as well as removable media (e.g., Flash memory, a removable hard drive, an optical disc, and so forth). The computer-readable media 122 may be configured in a variety of other ways as further described below. Several modules such as instructions, data stores, and so forth may be stored within the computer-readable media 122 and configured to execute on the processors 120.

The communication interface(s) 124 can facilitate communication with other proximate sensor systems and/or other facility systems. The communications interfaces(s) 124 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

In the current example, the 3D volumetric model or mesh 102 showing localized anatomical landmarks 126. In some cases, the 3D volumetric model or mesh 102 and the localized anatomical landmarks 126 may be utilized or provided to manufacturers for production of precise custom fit equipment or accessories for the user represented by the 3D volumetric model or mesh 102. For example, custom glasses, helmets, casts, gloves, and/or the like may be produced using the localized anatomical landmarks 126 and the 3D volumetric model or mesh 102.

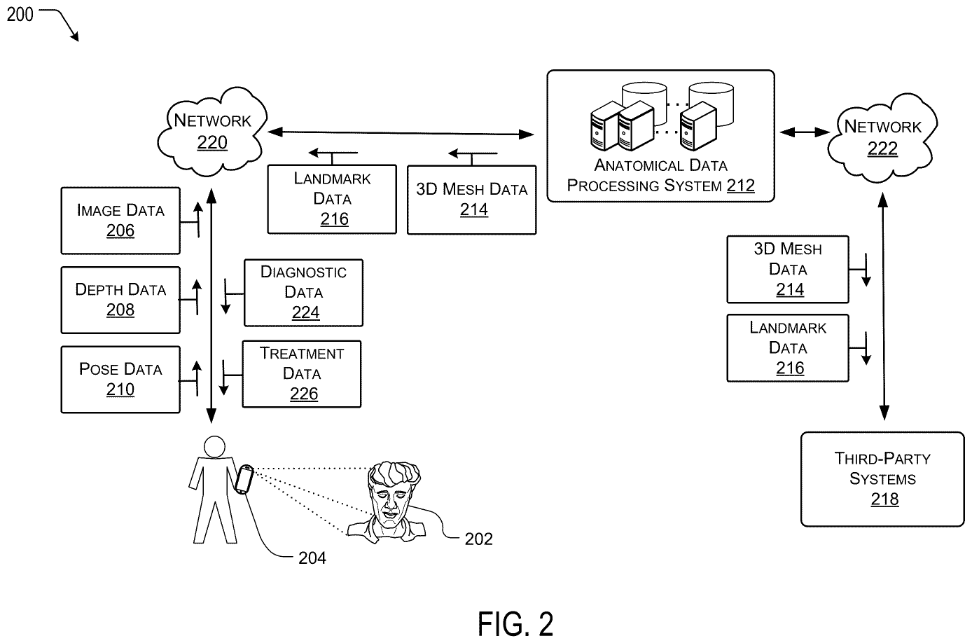

FIG. 2 is an example block diagram of an architecture for the system 200 for generating three-dimensional meshes or models of a feature 202 (e.g., a face or head) of an individual with precise anatomical landmarks according to some implementations. In the current example, the user equipment 204, such as a sensor device and a processing device, may be used to capture and/or otherwise generate image data 206 (e.g., 2D image data), depth data 208, and/or pose data 210 on a frame by frame basis while scanning the feature 202 (e.g., in the current example, a face or head) of a human body or patient.

In the current example, the user equipment 206 proximate to the feature 202 may capture the 2D image data 206 and corresponding the depth data 208 (e.g., the depth data 208 and the image data 206 may be time stamped corresponding frames). The user equipment 206 may also generate pose data 210 associated with the user equipment 204, the position of the camera or image device, and/or the position of the depth sensor. In the current example, the image data 206, depth data 208, and pose data 210 may be provided to an anatomical data processing system 212, such as located at least in part in the cloud. The anatomical data processing system 212 may generate a 3D mesh (e.g., 3D mesh data 214) associated with the image data 208 and the depth data 208 representative of the feature 202 (e.g., the face or head). The anatomical data processing system 212 may also determine a localization of one or more anatomical landmarks (e.g., the landmark data 216) with respect to the 3D mesh data 214. In this manner, the 3D mesh may be generate including precise positioning of the one or more anatomical landmarks.

The anatomical data processing system 204 may then provide the 3D mesh data 214 and/or the landmark data 212 back to the user equipment 204. The anatomical data processing system 204 may also provide the 3D mesh data 214 and/or the landmark data 212 to one or more third-party systems 218, such as a healthcare professional, custom production or manufacturing facility, and/or the like. For example, the anatomical data processing system 212 may provide the 3D mesh data 214 and/or the landmark data 212 to one or more health care providers assisting the patient with treatment, therapy, and/or unrelated conditions, one or more guardians or custodians, optometrist, ophthalmologist, and the like.

In some cases, the system 200 may be utilized to monitor the feature 204 or particular anatomical landmarks of the feature 204 over time, such as on a continuous basis, semi-continuous basis, periodic basis (at various frequencies), and/or the like. In these cases, the anatomical data processing system 212 may generate 3D mesh data 214 and/or the landmark data 216 at intervals, such that the anatomical data processing system 212 generates a multi-modal volumetric mesh including the precise placement of anatomical landmarks representative of the feature 202 at each interval or period of time. In this example, the anatomical data processing system 212 may compare the anatomical landmarks of the feature 202 over time to generate change data to assist with detection, monitoring, and treatment of various conditions. For example, the diagnosis of strabismus due to changes in the interpupil distance.

In some examples, the system 200 may also generate diagnostic data 224 and/or treatment data 226 associated with detected conditions or concerns associated with one or more anatomical landmarks of the feature 202. For example, by analyzing the anatomical landmarks of the feature 202 the system may assist with diagnostics or evaluations, flagged or identified potential conditions, symptoms as well as suggested treatments or therapies and the like. In some cases, system 200 may provide instructions to perform additional scans and/or capture additional image data or other types of sensor data associated with a specific user to enhance any recommendations or features identified. In one specific example, the cloud-based system may also return one or more additional inquiries for the healthcare professional and/or the patient, such as questions related to an accident, a particular feature, history of a feature, feature, or change in state detected, and the like to further assist the healthcare professionals in diagnostics and evaluation of the patient.

In some cases, as discussed herein, cloud-based processing may consist of multiple servers, available full-time and on demand, making their services substantially ubiquitous, constantly available, on demand and easily accessible (e.g., additional servers may be quickly activated in times of peak demand). Also, servers may consist of multiple computers in large service centers, using different operating systems, benefiting from lower-cost centralized utilities and services, and from expandable infrastructure, such as multiple parallel central processing units (CPUs), graphic processing units (GPUs), arithmetic logic units (ALUs), tensor processing units (TPUs) and quantum processing units (QPUs), to name a few. In general, cloud-servers may also be referred to as backend-servers or simply backend.

In the current example, the data, notifications, measurements, instructions, and the like may be transmitted between various systems using networks, generally indicated by 220 and 222. The networks 220 and 222 may be any type of network that facilitates compunction between one or more systems and may include one or more cellular networks, ZigBee, Bluetooth, radio, WiFi networks, short-range or near-field networks, infrared signals, local area networks, wide area networks, the internet, and so forth. In the current example, each network 220 and 222 is shown as a separate network but it should be understood that two or more of the networks may be combined or the same.

In the current example, some of the operations are shown as being performed by the anatomical data processing system 212, such as via a cloud-based system. It should be understood that in some implementations the operations of the cloud-based system or the anatomical data processing system 212 may be performed on device 204, such as via a local operation or on device operation. In other cases, the processing may be split between the device 204 and the anatomical data processing system 212 in various different ways.

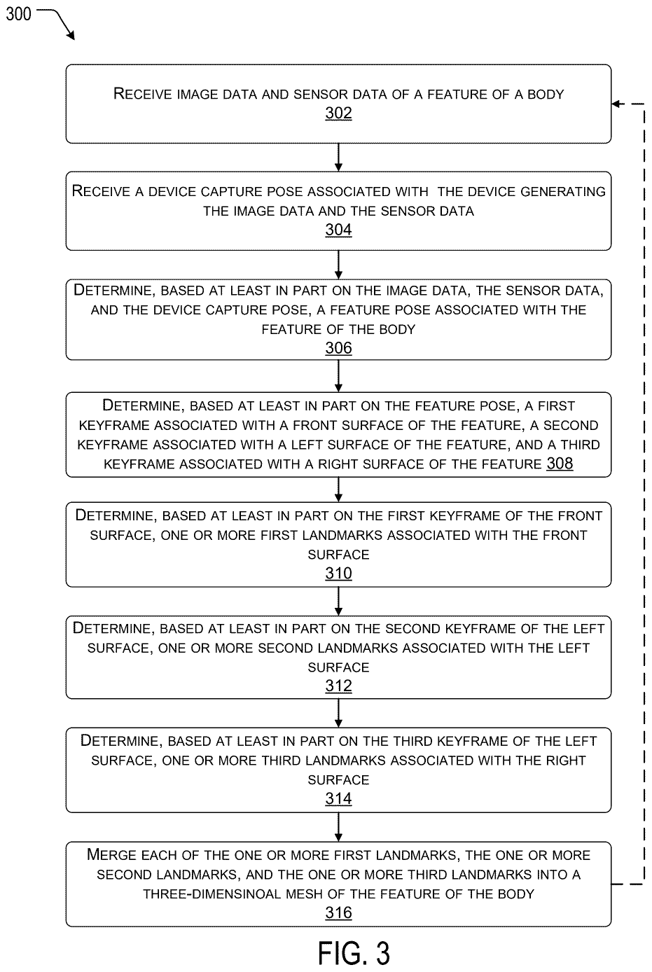

FIGS. 3-10 are flow diagrams illustrating example processes associated with the generating 3D meshes or models with precisely localized anatomical landmarks, as discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processor(s), perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 3 is an example process flow 300 associated with generating a three-dimensional model or mesh with precise anatomical landmarks associated with multiple surfaces or sides of the three-dimensional model according to some implementations. As discussed above, the system may be configured to receive and/or capture 2D color image data (e.g., frames) together with corresponding depth data of a feature (e.g., a face or head of an individual) and to generate a 3D mesh or model representing the feature. For example, the system may generate the 3D mesh or model of the feature utilizing a series of corresponding image and depth frames. In some cases, the system may utilize one or more machine learning models or networks that may receive the color image frames and corresponding depth frames as an input and in response output the 3D mesh or model. In the current example, once the 3D mesh or model is generated, the system may localize one or more anatomical landmarks associated with the feature precisely with respect to the 3D model or mesh.

At 302, the system may receive image data (e.g., to the color image frames) and sensor data (e.g., depth data or frames) of a feature (e.g., a face or head) of a body. For example, a user, such as a healthcare professional, may utilize a user device or equipment (e.g., a smart phone, tablet, and/or other handheld sensor device) to capture a series of frames or video data of the feature. In some cases, the system may process the captured image data and depth data. In other cases, the image data and depth data may be captured by the local device and provided to the system via one or more networks.

At 304, the system may receive a device capture pose associated with the device generating the image data and the sensor data. In some cases, the device capture pose may include a pose of the image device or camera, a pose of the sensor device for depth camera, and/or a pose of the user equipment itself. In some examples, the device capture pose may be one or more 6DOF poses associated with each 2D color image frame and the corresponding depth frame. In some implementations, the system may include a SLAM component and/or instructions configured to calculate determine the 6DOF pose or poses as the image data and the depth data is captured or generated.

At 306, the system may determine, based at least in part on the image data, the sensor data, and the device capture pose, a feature pose associated with the feature of the body. For example, the system may utilize one or more known techniques, such as perspective-n-points, for determining a feature pose based at least in part on to the image frame, depth data, and the device capture pose (e.g., a pose of the image device or camera and a pose of the depth sensor at the time the frames were captured). In some cases, the system may utilize one or more machine learning models or networks that may receive the corresponding color image frames and depth frames as well as the device capture pose as an input and, in response, output the feature pose. In some cases, the one or more machine learning models or networks may also perform segmentation, classification, feature detection and the like with respect to the feature based at least in part on the image frames, the depth frames, and the device capture pose.

At 308, the system may determine, based at least in part on the feature pose, a first keyframe associated with a front surface of the feature, a second keyframe associated with a left surface of the feature, and a third keyframe associated with a right surface of the feature. For example, the system may utilize perspective-n-point techniques for determining each of the keyframes associated with the front, left, and right side of the feature. In one specific example, the feature may be a head or face of an individual. In this example, the system may determine the first keyframe associated with the face of the user, the second keyframe associated with the left side of the head (e.g., the left ear of the individual), and the third keyframe associated with the right side of the head (e.g., the right ear of the individual).

At 310, the system may determine, based at least in part on the first keyframe, one or more first landmarks associated with the front surface (e.g., the face) of the feature (e.g., the head). For example, the system may utilize one or more machine learning model trained to detect landmarks, to detect face and facial landmarks. For example, the first landmarks may include the nasion, each pupil (e.g., a center of each pupil), the pronasale (e.g., nose tip), the subnasale, the labiale superius, the stomion, the labiale inferius, the gnathion (e.g., chin), the endocanthion, the exocanthion, the alare, the subalare, the crista philtra, each chelion, and the like.

At 312, the system may determine, based at least in part on the second keyframe, one or more second landmarks associated with the left surface (e.g., the left ear or side of the head) of the feature (e.g., the head) and, at 314, the system may determine, based at least in part on the third keyframe, one or more third landmarks associated with the right surface (e.g., the right ear or right of the head) of the feature (e.g., the head). For example, the system may again utilize one or more machine learning models trained to detect landmarks and the like to detect face and facial landmarks, including ear landmarks. For example, the second landmarks may include a left otobasion superioris, a left concha superioris, a left tragus superioris, a left intertragic incisure, a left otobasion inferioris, a left helix basal border, a left crus helix, and the like. Likewise, the third landmarks may include a right otobasion superioris, a right concha superioris, a right tragus superioris, a right intertragic incisure, a right otobasion inferioris, a right helix basal border, a right crus helix, and the like.

In some cases, the system may utilize one or more machine learning models or networks that may be trained on keyframe data to receive the keyframes (e.g., the first, second, and/or third keyframes) as an input and in response output various anatomical landmarks or facial landmarks. In some examples, the one or more machine learning models maybe trained on image data, depth data, feature poses of various anatomical features, including but not limited to faces, heads, portions of faces, and the like associated with various individuals (e.g., of various demographics, such as cultures, ages, genders, and the like) in various poses (e.g., looking up, down, forward, and the like), profiles, and positions. In some cases, the one or more machine learning models or networks may also perform segmentation, classification, feature detection and the like with respect to the feature (e.g., the head or face) based at least in part on the keyframes.

At 316, the system may merge each of the one or more first landmarks, the one or more second landmarks, and the one or more third landmarks into a 3D mesh or model of the feature of the body. In some cases, merging may include projecting each of the landmarks into the 3D mesh or model based at least in part on the corresponding the 2D keyframes. For instance, the system may utilize the X and Y image coordinates of each landmarks associated with the keyframes. Then the system may determine the Z (depth) coordinate for each landmark using the depth intrinsics, extrinsics, and frame. In some cases, the system may use utilize the feature pose, the image device camera pose, and/or the depth pose (e.g., the capture device pose) to transfer the X, Y, and Z coordinates to a world frame associated with the 3D mesh.

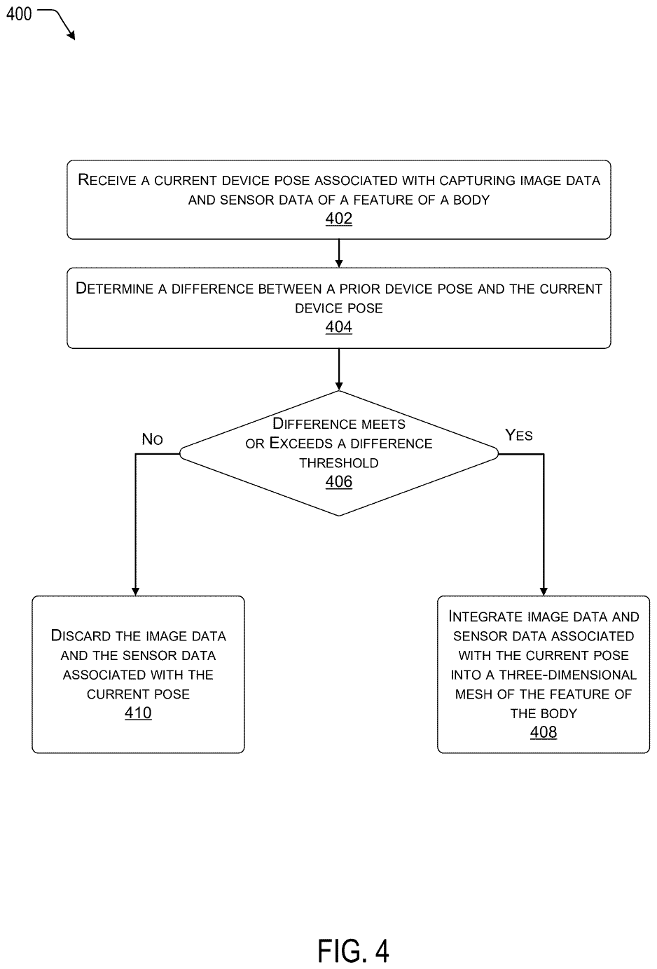

FIG. 4 is an example process flow 400 associated with determining if particular fames of image data and depth data are integrated into the 3D mesh or model or unitized to assist with localizing anatomical landmarks with respect to the 3D mesh or model according to some implementations. As discussed above, the system may be configured to receive and/or capture 2D color image data (e.g., frames) together with corresponding depth data of a feature (e.g., a face or head of an individual) and to generate a 3D mesh or model representing the feature. However, in some cases, the system may discard some of the corresponding image and depth frames to improve overall processing time and reduce resource consumption. In some case, the corresponding frames may be selected as follows.

At 402, the system may receive a current device pose associated with capturing the image data (e.g., a 2D color image frame) and sensor data (e.g., a depth fame) of a feature (e.g., a face or head) of a body. In some cases, the device capture pose may include a pose of the image device or camera, a pose of the sensor device for depth camera, and/or a pose of the user equipment itself. In some examples, the device capture pose may be one or more 6DOF poses associated with each 2D color image frame and the corresponding depth frame. In some implementations, the system may include a SLAM component and/or instructions configured to calculate determine the 6DOF pose or poses as the image data and the depth data is captured or generated.

At 404, the system may determine a difference between a prior device pose and the current device pose. For example, the system may determine a difference between the prior device pose and the current device pose in each of the six degrees of freedom. In some cases, the system may determine a single difference counting for each of the six degrees of freedom.

At 406, if the difference meets or exceeds a difference threshold, the process 400 may proceed to 408. Otherwise, the process 400 may advance to 410. For example, the system may compare the difference in each of the six degrees of freedom to an individual difference threshold associated with the corresponding degree of freedom. In other cases, the system may aggregate the difference in each of the six degrees and compare to a common difference threshold.

At 408, the system may integrate the image data (e.g., the 2D color image frame) and the sensor data (e.g., the depth frame) associated with the current pose into a 3D mesh or model of the feature of the body. In some cases, the system may also utilize the image data and the sensor data associated with the current pose to determine a localization of one or more anatomical landmarks with respect to the 3D mesh or model.

At 410, the system may discard the image data and the sensor data associated with the current pose. In this manner, the current 2D image frame and corresponding depth frame are not integrated into the 3D mesh or model nor utilized to determine localization of one or more anatomical landmarks with respect to the 3D mesh or model of the feature.

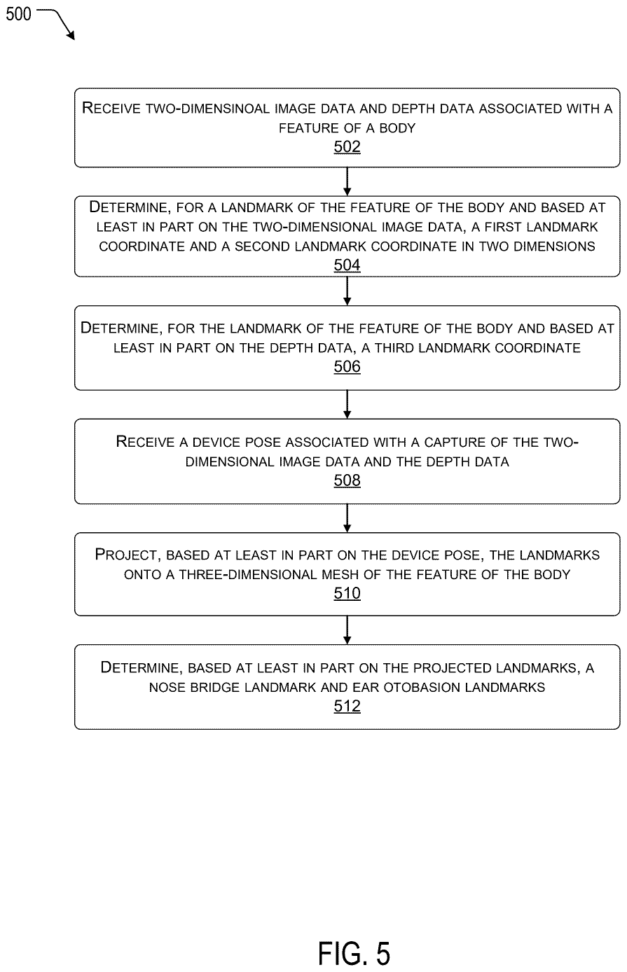

FIG. 5 is an example process flow 500 associated with localizing anatomical landmarks with respect to the 3D mesh or model according to some implementations. As discussed above, the system may be configured to receive and/or capture 2D color image data (e.g., frames) together with corresponding depth data of a feature (e.g., a face or head of an individual) and to generate a 3D mesh or model representing the feature. In some cases, the system may localize one or more anatomical landmarks associated with the feature precisely with respect to a 3D model or mesh of the feature (e.g., the face or head).

At 502, the system may receive 2D image data (e.g., to the color image frames) and depth data (e.g., a corresponding depth frame) of a feature (e.g., a face or head) of a body. For example, a user, such as a healthcare professional, may utilize a user device or equipment (e.g., a smart phone, tablet, and/or other handheld sensor device) to capture a series of frames or video data of the feature. In some cases, the system may be the user equipment may process the captured image data and depth data. In other cases, the image data and depth data may be captured by the local device and provided to the system via one or more networks.

At 504, the system may determine, for a landmark of the feature of the body and based at least in part on the 2D image data, a first landmark coordinate and a second landmark coordinate (e.g., the length and width coordinates or the X and Y coordinates) in the two dimensions associated with the 2D image data or frame. For example, the system may utilize one or more machine learning models to determine the first landmark coordinate and the second landmark coordinate.

At 506, the system may determine, for the landmark of the feature of the body and based at least in part on the depth data, a third landmark coordinate. For example, the system may utilize the first landmark coordinate and the second landmark coordinate of the landmarks together with the depth intrinsics and extrinsics associated with the depth frame to determine the third landmark coordinate (e.g., the depth coordinate or the Z coordinate).

At 508, the system may receive a device pose associated with a capture of the 2D image data and the depth data. In some cases, the device pose may include a pose of the image device or camera, a pose of the sensor device or depth camera, and/or a pose of the user equipment itself. In some examples, the device pose may be one or more 6DOF poses associated with each 2D color image frame and the corresponding depth frame. In some implementations, the system may include a SLAM component and/or instructions configured to calculate determine the 6DOF pose or poses as the image data and the depth data is captured or generated.

At 510, the system may project, based at least in part on the device pose, the landmarks onto the 3D mesh of the feature of the body. For example, the system may project the landmark at the 2D coordinate (e.g., the first landmark coordinate and the second landmark coordinate) in the 3D mesh utilizing the depth data and the device pose to determine the precise localization of the landmark with respect to the 3D mesh or model.

At 512, the system may determine, based at least in part on the projected landmarks, a nose bridge landmark and ear otobasion landmarks coordinates. For example, the system may utilize the positions of the projected landmarks to determine a canonical axes with respect to the landmarks and the mesh. Once the mesh is aligned, the system may determine the additional landmarks, e.g., the nose bridge landmark and the ear otobasion landmark, with respect to the other projected landmark coordinates.

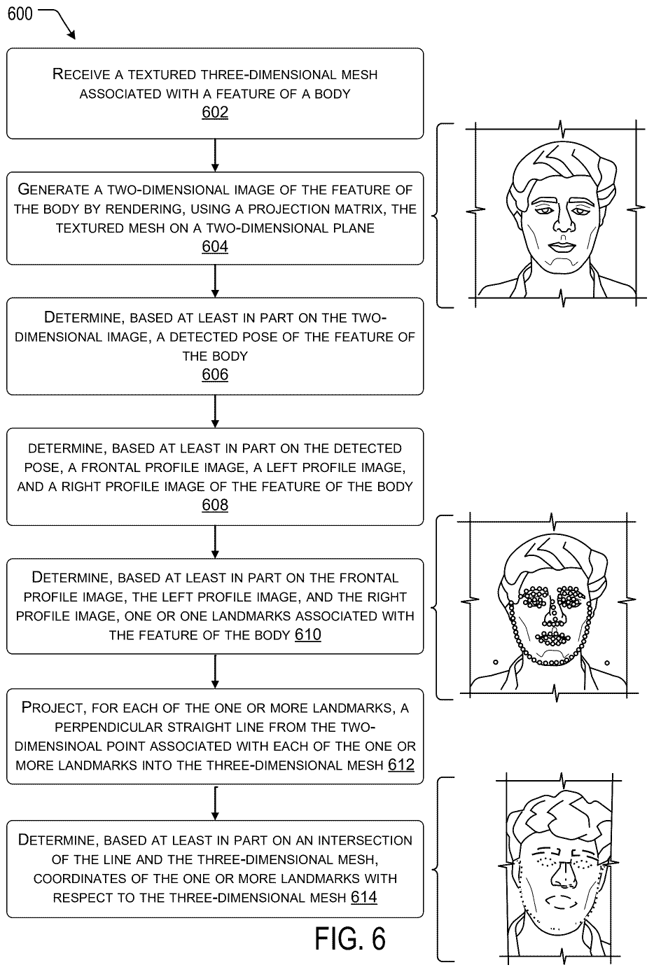

FIG. 6 is another example process flow 600 associated with localizing anatomical landmarks with respect to the 3D mesh or model according to some implementations. As discussed above, the system may be configured to receive and/or capture 2D color image data (e.g., frames) together with corresponding depth data of a feature (e.g., a face or head of an individual) and to generate a 3D mesh or model representing the feature. In some cases, the system may localize one or more anatomical landmarks associated with the feature precisely with respect to a 3D model or mesh of the feature (e.g., the face or head).

At 602, the system may receive a textured 3D mesh or model associated with a feature (e.g., face or head) of a body. For example, the system may generate a textured 3D mesh or model of the feature of the body based in part on image data and depth data captured during the scanning session. In some cases, the system may utilize the textured models to generate 2D images that may then be used as inputs to one or more machine learning models trained to detect and locate anatomical landmarks.

At 604, the system may generate a 2D image of the feature of the body by rendering, using a projection matrix, the textured mesh on the 2D plane. In this manner, the system may generate a 2D image of the feature of the body utilizing the 3D model or mesh. In some cases, the system may generate multiple 2D images from the textured 3D mesh such as to include a right and left profile image of the feature of the body (e.g., the head).

At 606, the system may determine, based at least in part on the 2D image, a detected pose of the feature of the body. For example, the system may utilize one or more machine learning models trained to detect features and landmarks of the body (e.g., faces and landmarks associated with the face or head). In some instances, the system may apply a perspective-n-projection to the output of the one or more machine learning models (e.g., the face) to determine the pose of the feature (e.g., the head) with respect to the 2D images of the feature of the body.

At 608, the system may determine, based at least in part on the detected pose, a frontal profile image, a left profile image, and a right profile image of the feature of the body.

At 610, the system may determine, based at least in part on the frontal profile image, the left profile image, and the right profile image, one or more landmarks associated with the feature of the body. In some cases, the one or more landmarks may include, but are not limited to, the nasion, each pupil (e.g., a center of each pupil), the pronasale (e.g., nose tip), the subnasale, the labiale superius, the stomion, the labiale inferius, the gnathion (e.g., chin), the endocanthion, the exocanthion, the alare, the subalare, the crista philtra, each chelion, each otobasion superioris, each concha superioris, each tragus superioris, each intertragic incisure, each otobasion inferioris, each helix basal border, each crus helix, and the like. In some examples, the anatomical landmarks may also include semi-landmarks, such as the eye corner, positioned along the edge of the exterior of the ear, and the like.

At 612, the system may project, for each of the one or more landmarks, a perpendicular straight-line from the 2D point on the profile images associated with each of the one or more landmarks into the 3D mesh or model and, at 614, the system may determine, based at least in part on an intersection of the perpendicular straight-line and the 3D mesh or model, coordinates of each of the one or more landmark with respect to the 3D mesh or model.

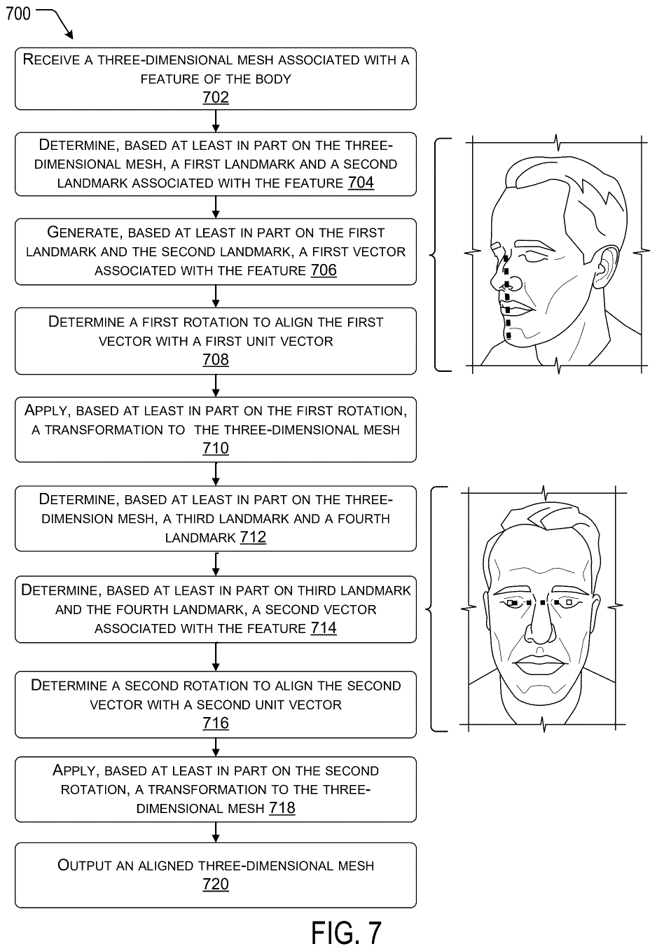

FIG. 7 is an example process flow 700 associated with aligning a three-dimensional mesh or model with a vertical and horizontal axis according to some implementations. As discussed above, the system may be configured to receive and/or capture 2D color image data (e.g., frames) together with corresponding depth data of a feature (e.g., a face or head of an individual) and to generate a 3D mesh or model representing the feature. For example, the system may generate the 3D mesh or model of the feature utilizing a series of corresponding image and depth frames. In some cases, the system may utilize one or more machine learning models or networks that may receive the color image frames and corresponding depth frames as an input and in response output the 3D mesh or model. In the current example, once the 3D mesh or model is generated, the system may localize one or more anatomical landmarks associated with the feature precisely with respect to the 3D model or mesh.

At 702, the system may receive a 3D mesh associated with a feature (e.g., the face or head) of the body. For example, the system may generate a 3D mesh or model of the feature of the body based at least in part on 2D color image data together with depth data received from a device physically proximate to the individual being scanned.

At 704, the system may determine, based at least in part on the 3D mesh, a first landmark and a second landmark associated with the feature. For example, the first landmark may be a position of the bridge of the nose of an individual and the second landmark may be a center of the bottom edge chin of the individual.

At 706, the system may generate, based at least in part on the first landmark and the second landmark, a first vector associated with the feature (e.g., the head or face). For example, the system may determine a vector between the bridge of the nodes in the bottom center edge of the chin. In this manner, the system may generate a vertical vector associated with the face of the individual.

At 708, the system may determine a first rotation to align the first vector with a first unit vector and, at 710, the system may apply, based at least in part on the first rotation, a transformation to the 3D mesh or model. For example, the system may determine a rotation in the one or more dimensions to align the vertical vector between the bridge of the nose and the bottom center edge of the chin with the first unit vector or the vertical. In this manner, the 3D mesh or model may be aligned with a vertical unit vector.

At 712, the system may determine, based at least in part on the 3D mesh, a third landmark and a fourth landmark associated with the feature. For example, the third landmark and the fourth landmark may be a middle or center point of each eye of the individual.

At 714, the system may generate, based at least in part on the third landmark and the fourth landmark, a second vector associated with the feature (e.g., the head or face). For example, the system may determine a vector between the center or middle of each eye. In this manner, the system may generate a horizontal vector associated with the face of the individual.

At 716, the system may determine a second rotation to align the second vector with a second unit vector and, at 718, the system may apply, based at least in part on the second rotation, a transformation to the 3D mesh or model. For example, the system may determine a rotation in the one or more dimensions to align the vertical vector the eyes of the individual with the second unit vector or the horizontal unit vector. In this manner, the 3D mesh or model may be aligned with a horizontal unit vector.

At 720, the system may output an aligned 3D mesh or model. For example, once the vertical and horizontal alignment of the 3D mesh or model with the unit vectors is determined, the system may begin to localize anatomical landmarks with respect to the 3D mesh or model in a precise manner.

In the current example, the feature is a face and the system utilizes anatomical landmarks associated with the eyes, nose, and chin to determine a vertical vector and horizontal vector which may be used to align the 3D mesh or model with the unit vectors. However, it should be understood that various other features of the body may be modeled and various other anatomical landmarks associated with the other features or part of the body may be utilized to determine a vertical vector and a horizontal vector that may be aligned with the unit vectors as discussed herein.

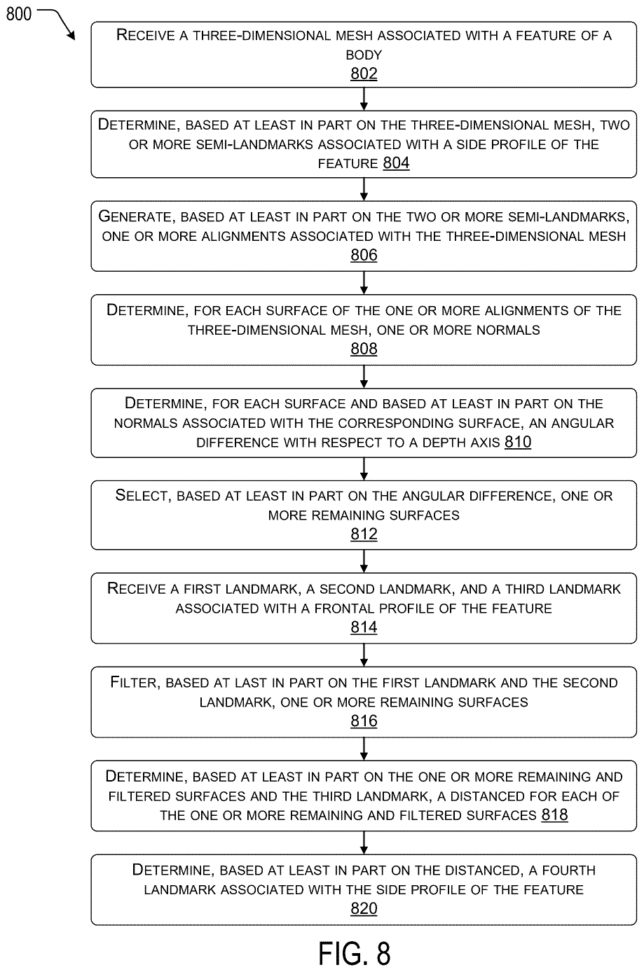

FIG. 8 is an example process flow 800 associated with localizing anatomical landmarks with respect to the 3D mesh or model according to some implementations. As discussed above, the system may be configured to receive and/or capture 2D color image data (e.g., frames) together with corresponding depth data of a feature (e.g., a face or head of an individual) and to generate a 3D mesh or model representing the feature. In some cases, the system may localize one or more anatomical landmarks associated with the feature precisely with respect to a 3D model or mesh of the feature (e.g., the face or head).

At 802, the system may receive a 3D mesh associated with a feature (e.g., the face or head) of the body. For example, the system may generate a 3D mesh or model of the feature of the body based at least in part on 2D color image data together with depth data received from a device physically proximate to the individual being scanned.

At 804, the system may determine, based at least in part on the 3D mesh or model, two or more semi-landmarks associated with a side profile (e.g., the left or right side of the face including the right or left ear) of the feature (e.g., the face or head). In some cases, the semi-landmarks may include positions associated with a feature such as the face, eyes, nose, ears, chin, and/or the like that may be determined by the system but are not anatomical landmarks in a medical sense. For example, in one implementation, the system may utilize 37 semi-landmarks associated with various positions along each ear to assist with proper alignment of the 3D model or mesh and/or placement of the anatomical landmarks. For instance, at least some of the 37 semi-landmarks may be positioned along the outer edge of the ear, inner edge of the ear, and/or the like. In one example, the semi-landmarks may be defined as points along a curve connecting two aromatical landmarks.

At 806, the system may generate, based at least in part on the two or more semi-landmarks, one or more alignments (e.g., coordinates, vectors, rotations, translations, and/or the like) associated with the 3D mesh or model, such as to align the mesh with a unit vector or canonical axes. In some cases, the system may also determine a scale or align a scale with a predetermined scale.

At 808, the system may determine, for each surface of the one or more alignments of the 3D mesh or model, one or more normals. For example, the surfaces may include a frontal profile, a left profile, a right profile, and/or the like associated with a face or head of an individual, such as when the face or head is the feature.

At 810, the system may determine, for each surface and based at least in part on the normals associated with the corresponding surface, and angular difference with respect to a depth axis and, at 812, the system may select, based at least in part on the angular difference, one or more remaining surfaces. For example, the system may select the surface who's normal has an angular difference is within a threshold difference from or closest to the depth axis (e.g., Z axis).

At 814, the system may receive a first landmark, a second landmark, and the third landmark associated with a frontal profile of the feature (e.g., the header face). For example, the system may utilize anatomical landmarks associated with the face, such as temporal jaw, a right eyebrow, a left eyebrow, and/or the like to assist with determining localizations of the anatomical landmarks associated with each ear. In some cases, the system may determine the anatomical landmarks associated with the frontal profile such as by the process 600 discussed above with respect to FIG. 6.

At 816, the system may filter, based at least in part on the first landmark and the second landmark, the one or more remaining surfaces. For example, the system may discard any of the one or more remaining surfaces in which the alignment results in a localization of the first landmark or the second landmark being greater than a threshold distance from an expected position. In some cases, the eyebrow top landmarks and the jaw top landmarks are sued to filter the remaining surfaces.

At 818, the system may determine, based at least in part on the one or more remaining and filtered surfaces and the third landmark, a distance for each of the one or more remaining and filtered surfaces. For instance, in this example, the third landmark may be either a right temporal jaw point or a left temporal jaw point (e.g., depending on the side surface being processed). In some cases, the distance may be a distance between the third landmark and one or more of the semi-landmarks and/or anatomical landmarks associated with the ear.

At 820, the system may determine, based at least in part on the distance, a fourth landmark associated with the site profile of the feature. For example, the system may utilize the distance to determine or localize and the otobasion superioris with respect to the 3D model or mesh. In one example, the system may select the point and the smallest distance between the corresponding temporal jaw point and a potential localization of the otobasion superioris as the localization of the otobasion superioris with respect to the 3D mesh or model.

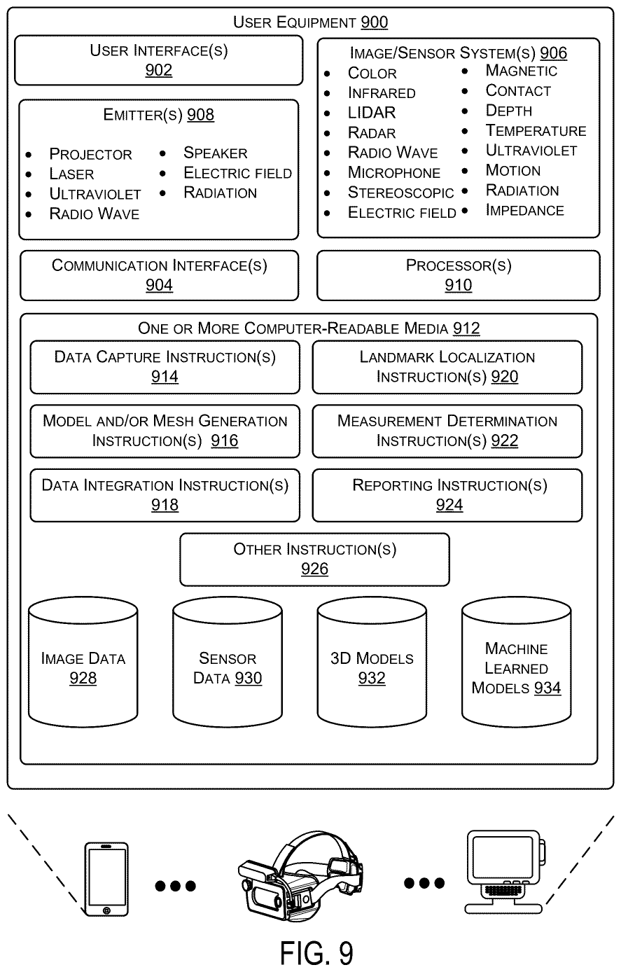

FIG. 9 is an example block diagram of an architecture for user equipment 900 associated with generating multi-modal volumetric data according to some implementations. The user equipment 900 may include one or more communication interface(s) 904 (also referred to as communication devices and/or modems), one or more sensor system(s) 906, and one or more emitter(s) 908.

The user equipment 900 can include one or more communication interface(s) 904 that enable communication between the user equipment 900 and one or more other local or remote computing device(s) or remote services. For instance, the communication interface(s) 904 can facilitate communication with other proximate sensor systems, a central control system, or other facility systems. The communications interfaces(s) 904 may enable Wi-Fi-based communication such as via frequencies defined by the IEEE 802.11 standards, short range wireless frequencies such as Bluetooth, Bluetooth low energy, ZigBee, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The one or more sensor system(s) 906 may be configured to capture the image data 928, the sensor data 930 (e.g., depth data), and the like associated with a feature of a body of a patient. In at least some examples, the sensor system(s) 906 may include thermal sensors, time-of-flight sensors, location sensors, LIDAR sensors, radar sensors, sonar sensors, infrared sensors, cameras (e.g., RGB, IR, intensity, depth, and the like), magnetic sensors, microphone sensors, environmental sensors (e.g., temperature sensors, humidity sensors, electric field probes, radio frequency (RF) antennas, impedance sensors, magnetic field sensors, photoplethysmography sensors, millimeter-wave radars, light sensors, pressure sensors, and the like), motion sensors, radiation sensors, and the like. In some examples, the sensor system(s) 906 may include multiple instances of each type of sensor. For instance, camera sensors may include multiple cameras disposed at various locations.

The user equipment 900 may also include one or more emitter(s) 908 for emitting light, radiation (e.g., x-rays, gamma rays, and the like), electric fields, and/or sound. By way of example and not limitation, the emitters 908 in this example may output illumination, fields, lasers, patterns, such as an array of light, audio, radiation, and the like.

The user equipment 900 may also include one or more user interfaces 902, such as input (e.g., mouse or keyboard) or output devices (e.g., a display). The user interfaces 902 may include a virtual environment display or a traditional two-dimensional display, such as a liquid crystal display or a light emitting diode display. The user interfaces 902 may also include one or more input components for receiving feedback from the user. In some cases, the input components may include tactile input components, audio input components, or other natural language processing components. In one specific example, the user interfaces 302 may be a combined touch enabled display.

The user equipment 900 may include one or more processors 910 and one or more computer-readable media 912. Each of the processors 910 may itself comprise one or more processors or processing cores. The computer-readable media 912 is illustrated as including memory/storage. The computer-readable media 912 may include volatile media (such as random access memory (RAM)) and/or nonvolatile media (such as read only memory (ROM), Flash memory, optical disks, magnetic disks, and so forth). The computer-readable media 912 may include fixed media (e.g., RAM, ROM, a fixed hard drive, and so on) as well as removable media (e.g., Flash memory, a removable hard drive, an optical disc, and so forth). The computer-readable media 912 may be configured in a variety of other ways as further described below.

Several modules such as instructions, data stores, and so forth may be stored within the computer-readable media 912 and configured to execute on the processors 910. For example, as illustrated, the computer-readable media 912 may store instructions including data capture instructions 914, model or mesh generation instructions 916, data integration instructions 918, landmark localization instructions 920, measurement determination instruction 922, reporting instructions 924, as well as other instructions 926, such as an operating system. The computer-readable media 912 may also be configured to store data, such as the image data 928, the sensor data 930, 3D meshes or models 932, machine learned models 934, and the like.

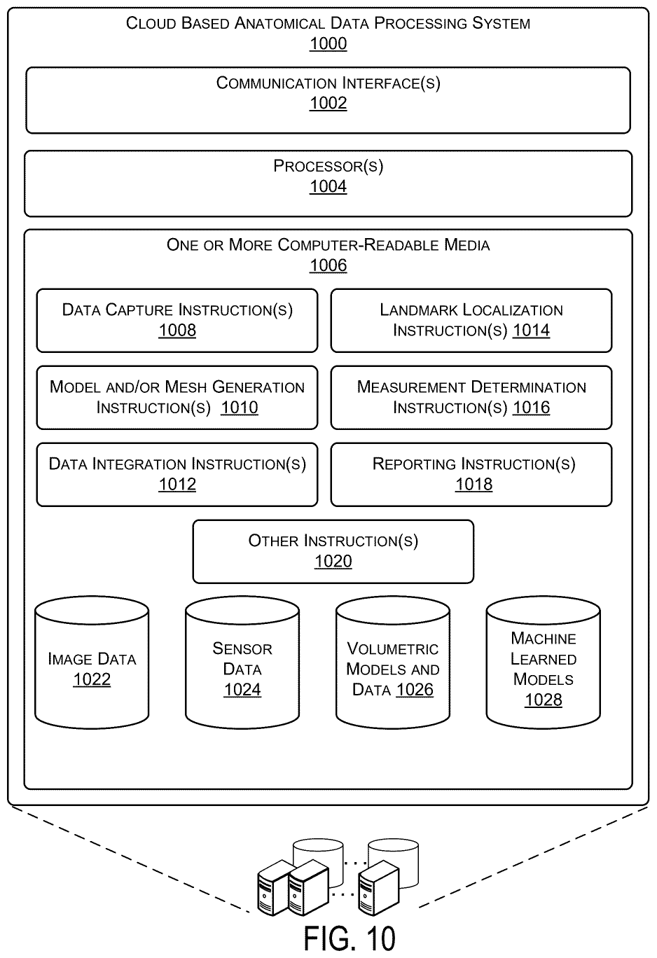

FIG. 10 is an example block diagram of an architecture for a cloud-based anatomical data processing system 1000 associated with generating multi-modal volumetric data according to some implementations. The cloud-based anatomical data processing system 1000 can include one or more communication interface(s) 1002 that enables communication between the cloud-based anatomical data processing system 1000 and one or more other local or remote computing device(s) or remote services, such as the user equipment. For instance, the communication interface(s) 1002 can facilitate communication with other proximate sensor systems and/or other facility systems. The communications interfaces(s) 1002 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The cloud-based anatomical data processing system 1000 may include one or more processors 1004 and one or more computer-readable media 1006. Each of the processors 1004 may itself comprise one or more processors or processing cores. The computer-readable media 1006 is illustrated as including memory/storage. The computer-readable media 1006 may include volatile media (such as random access memory (RAM)) and/or nonvolatile media (such as read only memory (ROM), Flash memory, optical disks, magnetic disks, and so forth). The computer-readable media 1006 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Several modules such as instructions, data stores, and so forth may be stored within the computer-readable media 1006 and configured to execute on the processors 1004. For example, as illustrated, the computer-readable media 1006 stores instructions including data capture instructions 1008, model or mesh generation instructions 1010, data integration instructions 1012, landmark localization instructions 1014, measurement determination instruction 1016, reporting instructions 1018, as well as other instructions 1020, such as an operating system. The computer-readable media 1006 may also be configured to store data, such as the image data 1022, the sensor data 1024, 3D models and meshes 1026, machine learned models 1028, and the like.

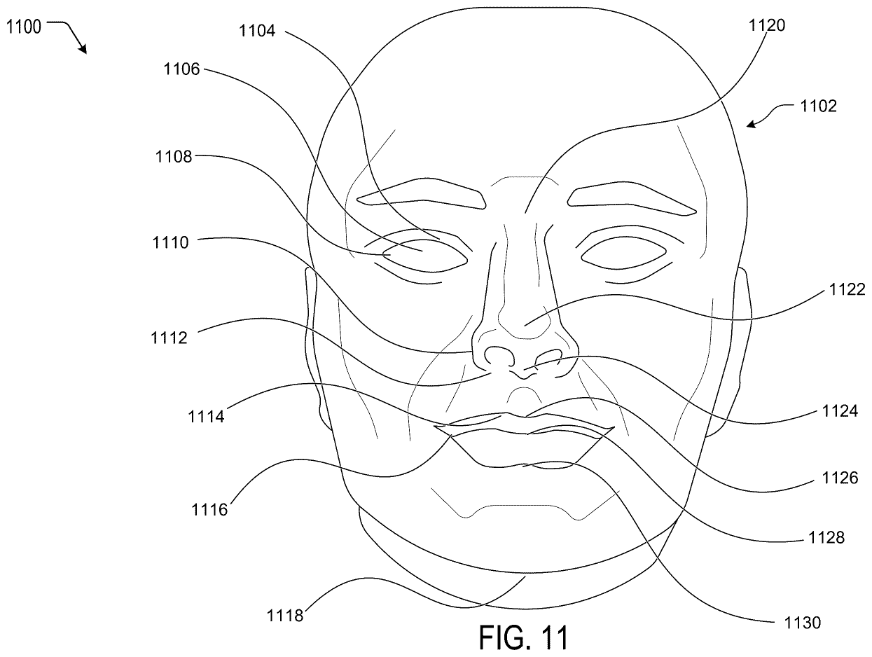

FIG. 11 is an example pictorial diagram of a three-dimensional mesh or model 1100 of a face or head 1102 of a user indicating various anatomical landmarks 1104-1130 that may be determined based on the systems and methods discussed above with respect to FIGS. 1-10 according to some implementations. In the current example, the systems and methods of FIGS. 1-10 may be utilized to generate the 3D mesh or model 1100 and precisely localize the anatomical landmarks 1104-1130 with respect to the 3D mesh or model 1100 as illustrated.

In the current example, the anatomical landmarks 1104 represents an endocanthion. The anatomical landmarks 1106 represents a pupil (e.g., a center of the pupil). The anatomical landmarks 1108 represents an exocanthion. The anatomical landmarks 1110 represents an alare. The anatomical landmarks 1112 represents a subalare. The anatomical landmarks 1114 represents a crista philtra. The anatomical landmarks 1116 represents a chelion. The anatomical landmarks 1118 represents the gnathion (e.g., a center point of the chin). The anatomical landmarks 1120 represents the nasion. The anatomical landmarks 1122 represents the pronasale (e.g., the tip of the nose). The anatomical landmarks 1124 represents the subnasale. The anatomical landmarks 1126 represents the labiale superius. The anatomical landmarks 1128 represents the stomion. The anatomical landmarks 1130 represents the labiale inferius.

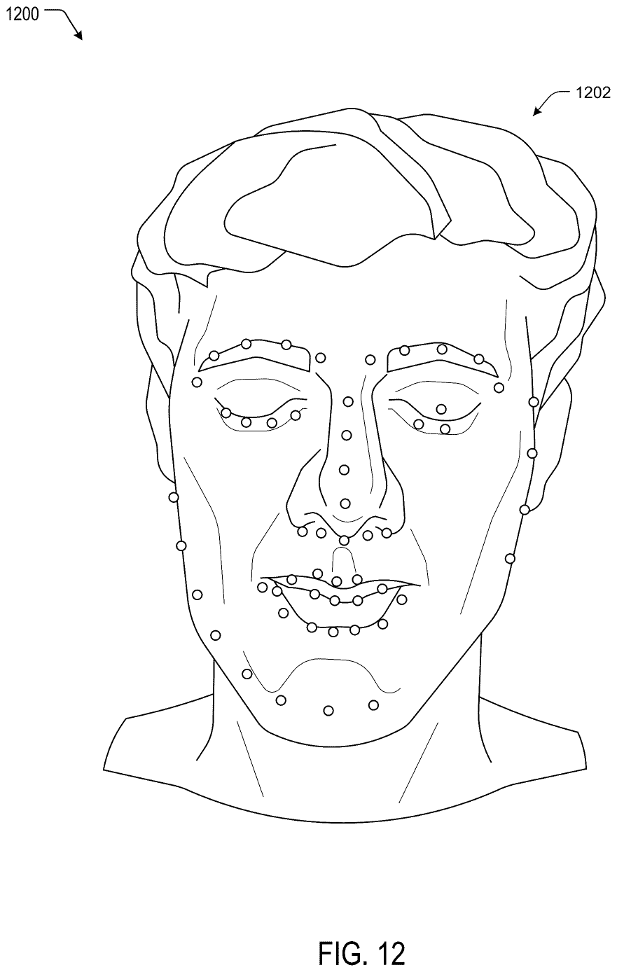

FIG. 12 is an example pictorial diagram 1200 of the anatomical landmarks of FIG. 11, such as landmarks 1104-1130, projected onto three-dimensional mesh or model 1202 of a face or head of a user according to some implementations. In the current example, the landmarks are projected and/or localized on the 3D model or mesh 1202 as discussed herein and indicated as both the right and left position of each landmark.

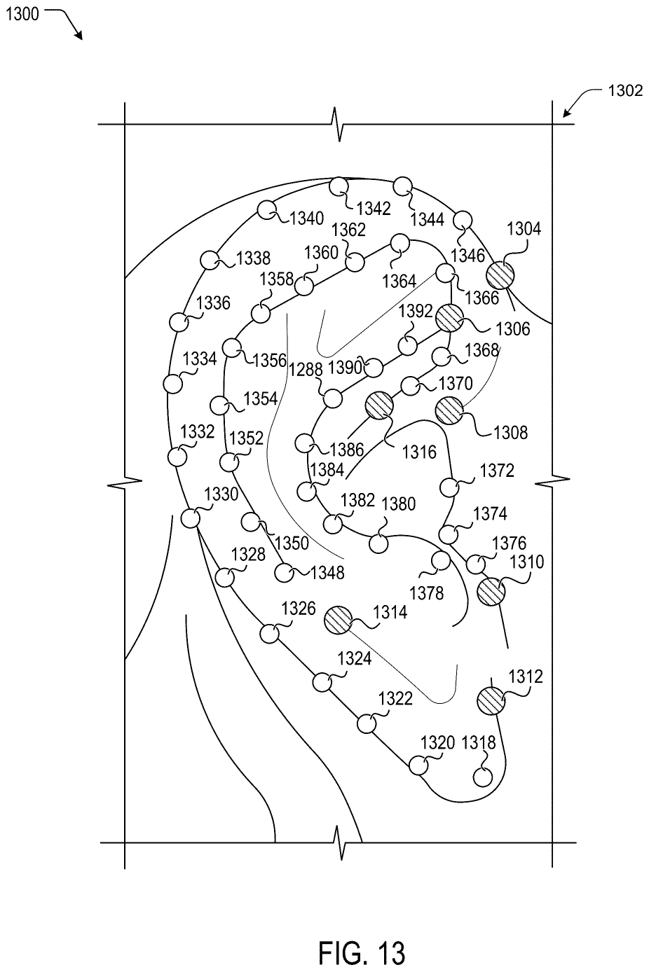

FIG. 13 is another example pictorial diagram 1300 of a three-dimensional mesh or model 1302 of an ear of a user indicating various anatomical landmarks 1302-1316 that may be determined based on the systems and methods discussed above with respect to FIGS. 1-10 according to some implementations. In the illustrated example, the right side of the model 1302 including the right ear of the user is illustrated and includes various anatomical landmarks of the right ear. It should be understood that corresponding anatomical landmarks may be included in the 3D mesh or model 1302 for the left side of the head or the left ear.

In this example, the anatomical landmarks 1304 represents the otobasion superioris, the anatomical landmarks 1306 represents the concha superioris, the anatomical landmarks 1308 represents the tragus superioris, the anatomical landmarks 1310 represents the intertragic incisure, the anatomical landmarks 1312 represents the otobasion inferioris, the anatomical landmarks 1314 represents the helix basal border, and the anatomical landmarks 1316 represents the crus helix. In this example, various semi-landmarks are also illustrated. As discussed above, the semi-landmarks are usable to assist in localizing the anatomical landmarks with respect to the 3D model or mesh 1302. In this example, the semi-landmarks are illustrated generally with respect to elements 1318-1392. In general, the semi-landmarks 1318-1392 may include positions along the curve connecting two of the anatomical landmarks 1304-1316.

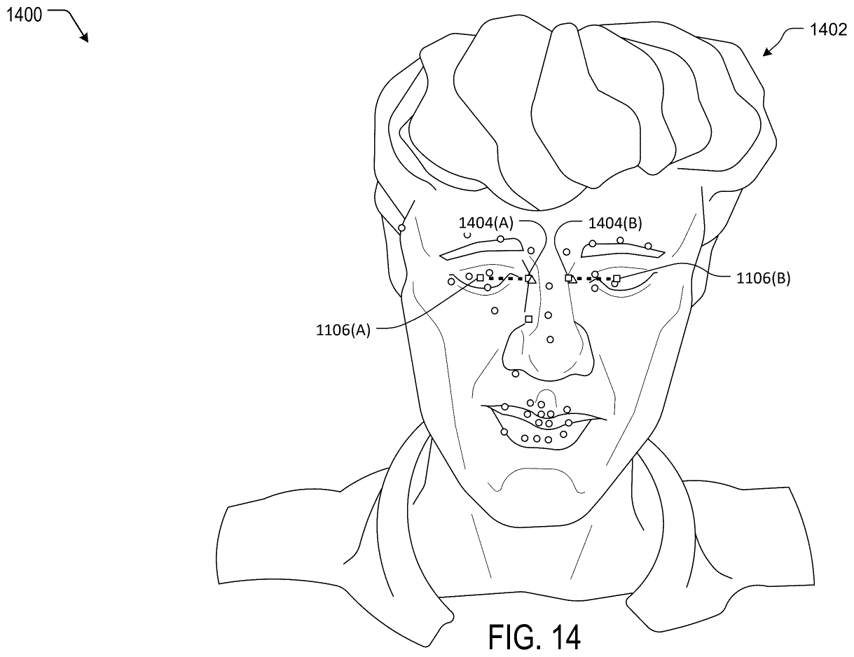

FIG. 14 is an example pictorial diagram 1400 additional anatomical landmarks and/or measurements useful for manufacturing of custom headgear projected onto three-dimensional mesh or model 1402 of a face or head of a user according to some implementations. In particular, using the anatomical landmarks 1104-1130 of FIGS. 11 and 12, the system may determine, as discussed above, a width of a nose bridge of the user represented in the 3D mesh or model 1402. For instance, the system may project a ray from each of the pupil centers 1106(A) and 1106(B) into the nose of the user. The system may determine the positions 1404(A) and 1404(B) as the intersection of each ray and the bridge of the nose of the user. The system may then determine the distance between the positions 1404(A) and 1404(B) to determine the width of the noise bridge.

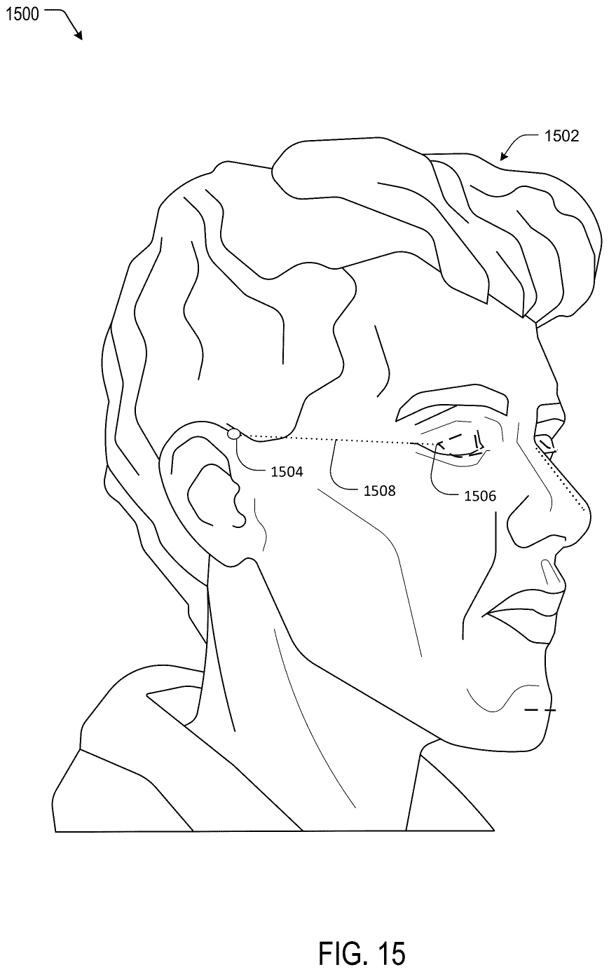

FIG. 15 is another example pictorial diagram 1500 additional anatomical landmarks and/or measurements useful for manufacturing of custom headgear projected onto three-dimensional mesh or model 1502 of a face or head of a user according to some implementations. In the current example, for each side of the head, the system may localize the otobasion superioris 1504 and the exocanthion 1506 with respect to the 3D model or mesh 1502, as discussed above. The system may then determine the distance 1508 between the otobasion superioris 1504 and the exocanthion 1506 to determine a distance between the ear and eyes of the user.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

### EXAMPLE CLAUSES

A. A method comprising: receiving, from a user device, depth data and two-dimensional image data of a feature of a body; generating, based at least in part on the depth data and the two-dimensional image data, a three-dimensional mesh of the feature of the body; receiving, from the user device, pose data associated with a pose of the user device at a time the depth data and the two-dimensional image data was captured; generating, based at least in part on the pose data and the three-dimensional mesh, a feature pose associated with the three-dimensional mesh of the feature of the body; and localizing, based at least in part on the feature pose, one or more anatomical landmarks with respect to the three-dimensional mesh of the feature of the body.

B. The method of A, further comprising: determining a difference between the pose data of a first frame and a second frame, the second frame subsequent to the first frame; and wherein responsive to determining that the difference is greater than or equal to a difference threshold, generating the three-dimensional mesh of the feature of the body.

C. The method of A, further comprising: determining, based at least in part on the feature pose, a first keyframe associated with a front surface of the feature, a second keyframe associated with a right surface of the feature, and a third keyframe associated with a left surface of the feature; and wherein localizing the one or more anatomical landmarks with respect to the three-dimensional mesh of the feature of the body is based at least in part on the first keyframe, the second keyframe, and the third keyframe.

D. The method of C, further comprising: determining, based at least in part on the first keyframe, one or more first anatomical landmarks associated with the front surface; determining, based at least in part on the second keyframe, one or more second anatomical landmarks associated with the right surface; determining, based at least in part on the third keyframe, one or more third anatomical landmarks associated with the left surface; and wherein the one or more anatomical landmarks includes the one or more first anatomical landmarks, the one or more second anatomical landmarks, and the one or more third anatomical landmarks.

E. The method of A, wherein localizing the one or more anatomical landmarks with respect to the three-dimensional mesh of the feature of the body further comprises for each landmark of the one or more anatomical landmarks: determining, based at least in part on the two-dimensional image data, a first landmark coordinate and a second landmark coordinate; determining, based at least in part on the depth data, a third landmark coordinate; and wherein localizing the one or more anatomical landmarks with respect to the three-dimensional mesh of the feature of the body is based at least in part on projecting, based at least in part on the pose data associated with the pose of the user device at the time the depth data and the two-dimensional image data was captured, the landmark onto the three-dimensional mesh.

F. The method of A, wherein: the three-dimensional mesh is a textured three-dimensional mesh, generating the feature pose further comprises: generating, based at least in part on the textured three-dimensional mesh and a projection matrix, a two-dimensional surface; determining, based at least in part on the two-dimensional surface, the feature pose, and the method further comprises: determining, based at least in part on the feature pose, a frontal profile image, a left profile image, and a right profile image of the feature of the body; determining, based at least in part on the frontal profile image, the left profile image, and the right profile image of the feature of the body, the one or more anatomical landmarks, and localizing the one or more anatomical landmarks with respect to the three-dimensional mesh of the feature of the human body further comprises: projecting, for each of the one or more anatomical landmarks, a perpendicular straight line from the two-dimensional point associated with a corresponding one of the frontal profile image, the left profile image, and the right profile image into the textured three-dimensional mesh.

G. The method of F, wherein localizing the one or more anatomical landmarks with respect to the three-dimensional mesh of the feature of the human body further comprises, for each landmark of the one or more anatomical landmarks: determining an intersection of the perpendicular straight line and the three-dimensional mesh; and determining, based at least in part on the intersection, coordinates for the anatomical landmark.

H. The method of A, wherein the feature of the body is a head.

I. The method of H, wherein the one or more anatomical landmarks includes one or more of: a nasion, a pupil, a pronasale, a subnasale, a labiale superius, a stomion, a labiale inferius, a gnathion, an endocanthion, an exocanthion, an alare, a subalare, a crista philtra, a chelion, an otobasion superioris, a concha superioris, a tragus superioris, an intertragic incisure, an otobasion inferioris, a helix basal border, or a crus helix.

J. A system comprising: a first sensor device to capture image data; a second sensor device to capture depth data; a pose tracking component to generate pose data associated with the system; one or more processors; and one or more non-transitory computer-readable media storing instructions that, when executed by the one or more processors, cause the one or more processors to perform operations comprising: receiving, from a user device, depth data and two-dimensional image data of a feature of a body; generating, based at least in part on the depth data and the two-dimensional image data, a three-dimensional mesh of the feature of the body; receiving, from the user device, pose data associated with a pose of the user device at a time the depth data and the two-dimensional image data was captured; generating, based at least in part on the pose data and the three-dimensional mesh, a feature pose associated with the three-dimensional mesh of the feature of the body; and localizing, based at least in part on the feature pose, one or more anatomical landmarks with respect to the three-dimensional mesh of the feature of the body.

K. The system of J, wherein localizing the one or more anatomical landmarks with respect to the three-dimensional mesh of the feature of the body further comprises: determining, based at least in part on the three-dimensional mesh, two or more semi-landmarks associated with a side profile of the feature; generating, based at least in part on the one or more semi-landmarks, one or more alignments associated with the three-dimensional mesh; determining, for each of the one or more alignments, one or more normals; determining, for each of the one or more alignments and based on the one or more normals, an angular difference with respect to a depth axis of the three-dimensional mesh and a global depth axis; discarding, based at least in part on the angular differences, at least one of the one or more alignment to generate one or more first remaining alignments; discarding, based at least in part on a first anatomical landmark and a second anatomical landmark, at least one of the one or more first alignments to generate one or more second remaining alignments; determining, for each of the one or more second remaining alignments, a distance associated with a third anatomical landmark; and localizing, based at least in part on the distance, a fourth landmark with respect to the three-dimensional mesh.

L. The system of K, wherein the distance is associated with at least one of the one or more semi-landmarks.

M. The system of K, wherein the third anatomical landmark is either a right or left temporal jaw point and the fourth anatomical landmark is either a right or left otobasion superioris.

N. The system of J, further comprising: determining, based at least in part on the feature pose, a first keyframe associated with a front surface of the feature, a second keyframe associated with a right surface of the feature, and a third keyframe associated with a left surface of the feature; determining, based at least in part on the first keyframe, one or more first anatomical landmarks associated with the front surface; determining, based at least in part on the second keyframe, one or more second anatomical landmarks associated with the right surface; determining, based at least in part on the third keyframe, one or more third anatomical landmarks associated with the left surface; and wherein the one or more anatomical landmarks includes the one or more first anatomical landmarks, the one or more second anatomical landmarks, and the one or more third anatomical landmarks.

O. The system of J, wherein: the three-dimensional mesh is a textured three-dimensional mesh, generating the feature pose further comprises: generating, based at least in part on the textured three-dimensional mesh and a projection matrix, a two-dimensional surface; determining, based at least in part on the two-dimensional surface, the feature pose, and the method further comprises: determining, based at least in part on the feature pose, a frontal profile image, a left profile image, and a right profile image of the feature of the body; determining, based at least in part on the frontal profile image, the left profile image, and the right profile image of the feature of the body, the one or more anatomical landmarks, and localizing the one or more anatomical landmarks with respect to the three-dimensional mesh of the feature of the human body further comprises: projecting, for each of the one or more anatomical landmarks, a perpendicular straight line from the two-dimensional point associated with a corresponding one of the frontal profile image, the left profile image, and the right profile image into the textured three-dimensional mesh.

P. One or more non-transitory computer-readable media storing instructions that, when executed by one or more processors, cause the one or more processors to perform operations comprising: generating, based at least in part on depth data and two-dimensional image data of a head, a three-dimensional mesh; receiving, from the user device, pose data associated with a pose of the user device at a time the depth data and the two-dimensional image data was captured; generating, based at least in part on the pose data and the three-dimensional mesh, a feature pose associated with the three-dimensional mesh of the head; and localizing, based at least in part on the feature pose, one or more anatomical landmarks with respect to the three-dimensional mesh of the head.

Q. The one or more non-transitory computer-readable media of P, wherein the operations further comprise: determining, based at least in part on the feature pose, a first keyframe associated with a front surface of the head, a second keyframe associated with a right surface of the head, and a third keyframe associated with a left surface of the head; determining, based at least in part on the first keyframe, one or more first anatomical landmarks associated with the front surface; determining, based at least in part on the second keyframe, one or more second anatomical landmarks associated with the right surface; determining, based at least in part on the third keyframe, one or more third anatomical landmarks associated with the left surface; and wherein the one or more anatomical landmarks includes the one or more first anatomical landmarks, the one or more second anatomical landmarks, and the one or more third anatomical landmarks.

R. The one or more non-transitory computer-readable media of P, wherein localizing the one or more anatomical landmarks with respect to the three-dimensional mesh of the head further comprises for each landmark of the one or more anatomical landmarks: determining, based at least in part on the two-dimensional image data, a first landmark coordinate and a second landmark coordinate; determining, based at least in part on the depth data, a third landmark coordinate; and wherein localizing the one or more anatomical landmarks with respect to the three-dimensional mesh of the head is based at least in part on projecting, based at least in part on the pose data associated with the pose of the user device at the time the depth data and the two-dimensional image data was captured, the landmark onto the three-dimensional mesh.

S. The one or more non-transitory computer-readable media of P, wherein localizing the one or more anatomical landmarks with respect to the three-dimensional mesh of the feature of the body further comprises: determining, based at least in part on the three-dimensional mesh, two or more semi-landmarks associated with a side profile of the feature; generating, based at least in part on the one or more semi-landmarks, one or more alignments associated with the three-dimensional mesh; filtering the one or more alignments, based at least in part on a first anatomical landmark and a second anatomical landmark, to generate one or more second alignments; determining, for each of the one or more remaining alignments, a distance associated with a third anatomical landmark; and localizing, based at least in part on the distance, a fourth landmark with respect to the three-dimensional mesh.

T. The one or more non-transitory computer-readable media of P, wherein: the three-dimensional mesh is a textured three-dimensional mesh, generating the feature pose further comprises: generating, based at least in part on the textured three-dimensional mesh and a projection matrix, a two-dimensional surface; determining, based at least in part on the two-dimensional surface, the feature pose, and the method further comprises: determining, based at least in part on the feature pose, a frontal profile image, a left profile image, and a right profile image of the head; determining, based at least in part on the frontal profile image, the left profile image, and the right profile image of the feature of the body, the one or more anatomical landmarks, and localizing the one or more anatomical landmarks with respect to the three-dimensional mesh of the head further comprises: projecting, for each of the one or more anatomical landmarks, a perpendicular straight line from the two-dimensional point associated with a corresponding one of the frontal profile image, the left profile image, and the right profile image into the textured three-dimensional mesh.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein. As can be understood, the components discussed herein are described as divided for illustrative purposes. However, the operations performed by the various components can be combined or performed in any other component. It should also be understood that components or steps discussed with respect to one example or implementation may be used in conjunction with components or steps of other examples.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving, from a user device, depth data and two-dimensional image data of a feature of a body;
generating, based at least in part on the depth data and the two-dimensional image data, a three-dimensional mesh of the feature of the body;
receiving, from the user device, pose data associated with a pose of the user device at a time the depth data and the two-dimensional image data was captured;
generating, based at least in part on the pose data and the three-dimensional mesh, a feature pose associated with the three-dimensional mesh of the feature of the body; and
localizing, based at least in part on the feature pose, one or more anatomical landmarks with respect to the three-dimensional mesh of the feature of the body.

2. The method of claim 1, further comprising:
determining a difference between the pose data of a first frame and a second frame, the second frame subsequent to the first frame; and
wherein responsive to determining that the difference is greater than or equal to a difference threshold, generating the three-dimensional mesh of the feature of the body.

3. The method of claim 1, further comprising:
determining, based at least in part on the feature pose, a first keyframe associated with a front surface of the feature, a second keyframe associated with a right surface of the feature, and a third keyframe associated with a left surface of the feature; and
wherein localizing the one or more anatomical landmarks with respect to the three-dimensional mesh of the feature of the body is based at least in part on the first keyframe, the second keyframe, and the third keyframe.

4. The method of claim 3, further comprising:
determining, based at least in part on the first keyframe, one or more first anatomical landmarks associated with the front surface;
determining, based at least in part on the second keyframe, one or more second anatomical landmarks associated with the right surface;
determining, based at least in part on the third keyframe, one or more third anatomical landmarks associated with the left surface; and
wherein the one or more anatomical landmarks includes the one or more first anatomical landmarks, the one or more second anatomical landmarks, and the one or more third anatomical landmarks.

5. The method of claim 1, wherein localizing the one or more anatomical landmarks with respect to the three-dimensional mesh of the feature of the body further comprises for each landmark of the one or more anatomical landmarks:
determining, based at least in part on the two-dimensional image data, a first landmark coordinate and a second landmark coordinate;
determining, based at least in part on the depth data, a third landmark coordinate; and
wherein localizing the one or more anatomical landmarks with respect to the three-dimensional mesh of the feature of the body is based at least in part on projecting, based at least in part on the pose data associated with the pose of the user device at the time the depth data and the two-dimensional image data was captured, the landmark onto the three-dimensional mesh.

6. The method of claim 1, wherein:
the three-dimensional mesh is a textured three-dimensional mesh,
generating the feature pose further comprises:
generating, based at least in part on the textured three-dimensional mesh and a projection matrix, a two-dimensional surface;
determining, based at least in part on the two-dimensional surface, the feature pose, and
the method further comprises:
determining, based at least in part on the feature pose, a frontal profile image, a left profile image, and a right profile image of the feature of the body;
determining, based at least in part on the frontal profile image, the left profile image, and the right profile image of the feature of the body, the one or more anatomical landmarks, and
localizing the one or more anatomical landmarks with respect to the three-dimensional mesh of the feature of the human body further comprises:
projecting, for each of the one or more anatomical landmarks, a perpendicular straight line from the two-dimensional point associated with a corresponding one of the frontal profile image, the left profile image, and the right profile image into the textured three-dimensional mesh.

7. The method of claim 6, wherein localizing the one or more anatomical landmarks with respect to the three-dimensional mesh of the feature of the human body further comprises, for each landmark of the one or more anatomical landmarks:
determining an intersection of the perpendicular straight line and the three-dimensional mesh; and
determining, based at least in part on the intersection, coordinates for the anatomical landmark.

8. The method of claim 1, wherein the feature of the body is a head.

9. The method of claim 8, wherein the one or more anatomical landmarks includes one or more of:
a nasion,
a pupil,
a pronasale,
a subnasale,
a labiale superius,
a stomion,
a labiale inferius,
a gnathion,
an endocanthion,
an exocanthion,
an alare,
a subalare,
a crista philtra,
a chelion,
an otobasion superioris,
a concha superioris,
a tragus superioris,
an intertragic incisure,
an otobasion inferioris,
a helix basal border, or
a crus helix.

10. A system comprising:
a first sensor device to capture image data;
a second sensor device to capture depth data;
a pose tracking component to generate pose data associated with the system;
one or more processors; and
one or more non-transitory computer-readable media storing instructions that, when executed by the one or more processors, cause the one or more processors to perform operations comprising:
receiving, from a user device, depth data and two-dimensional image data of a feature of a body;
generating, based at least in part on the depth data and the two-dimensional image data, a three-dimensional mesh of the feature of the body;
receiving, from the user device, pose data associated with a pose of the user device at a time the depth data and the two-dimensional image data was captured;
generating, based at least in part on the pose data and the three-dimensional mesh, a feature pose associated with the three-dimensional mesh of the feature of the body; and
localizing, based at least in part on the feature pose, one or more anatomical landmarks with respect to the three-dimensional mesh of the feature of the body.

11. The system of claim 10, wherein localizing the one or more anatomical landmarks with respect to the three-dimensional mesh of the feature of the body further comprises:
determining, based at least in part on the three-dimensional mesh, two or more semi-landmarks associated with a side profile of the feature;
generating, based at least in part on the one or more semi-landmarks, one or more alignments associated with the three-dimensional mesh;
determining, for each of the one or more alignments, one or more normals;
determining, for each of the one or more alignments and based on the one or more normals, an angular difference with respect to a depth axis of the three-dimensional mesh and a global depth axis;
discarding, based at least in part on the angular differences, at least one of the one or more alignment to generate one or more first remaining alignments;
discarding, based at least in part on a first anatomical landmark and a second anatomical landmark, at least one of the one or more first alignments to generate one or more second remaining alignments;
determining, for each of the one or more second remaining alignments, a distance associated with a third anatomical landmark; and
localizing, based at least in part on the distance, a fourth landmark with respect to the three-dimensional mesh.

12. The system of claim 11, wherein the distance is associated with at least one of the one or more semi-landmarks.

13. The system of claim 11, wherein the third anatomical landmark is either a right or left temporal jaw point and the fourth anatomical landmark is either a right or left otobasion superioris.

14. The system of claim 10, further comprising:
determining, based at least in part on the feature pose, a first keyframe associated with a front surface of the feature, a second keyframe associated with a right surface of the feature, and a third keyframe associated with a left surface of the feature;
determining, based at least in part on the first keyframe, one or more first anatomical landmarks associated with the front surface;
determining, based at least in part on the second keyframe, one or more second anatomical landmarks associated with the right surface;
determining, based at least in part on the third keyframe, one or more third anatomical landmarks associated with the left surface; and
wherein the one or more anatomical landmarks includes the one or more first anatomical landmarks, the one or more second anatomical landmarks, and the one or more third anatomical landmarks.

15. The system of claim 10, wherein:
the three-dimensional mesh is a textured three-dimensional mesh,
generating the feature pose further comprises:
generating, based at least in part on the textured three-dimensional mesh and a projection matrix, a two-dimensional surface;
determining, based at least in part on the two-dimensional surface, the feature pose, and
the method further comprises:
determining, based at least in part on the feature pose, a frontal profile image, a left profile image, and a right profile image of the feature of the body;
determining, based at least in part on the frontal profile image, the left profile image, and the right profile image of the feature of the body, the one or more anatomical landmarks, and
localizing the one or more anatomical landmarks with respect to the three-dimensional mesh of the feature of the human body further comprises:
projecting, for each of the one or more anatomical landmarks, a perpendicular straight line from the two-dimensional point associated with a corresponding one of the frontal profile image, the left profile image, and the right profile image into the textured three-dimensional mesh.

16. One or more non-transitory computer-readable media storing instructions that, when executed by one or more processors, cause the one or more processors to perform operations comprising:
generating, based at least in part on depth data and two-dimensional image data of a head, a three-dimensional mesh;
receiving, from the user device, pose data associated with a pose of the user device at a time the depth data and the two-dimensional image data was captured;
generating, based at least in part on the pose data and the three-dimensional mesh, a feature pose associated with the three-dimensional mesh of the head; and
localizing, based at least in part on the feature pose, one or more anatomical landmarks with respect to the three-dimensional mesh of the head.

17. The one or more non-transitory computer-readable media of claim 16, wherein the operations further comprise:
determining, based at least in part on the feature pose, a first keyframe associated with a front surface of the head, a second keyframe associated with a right surface of the head, and a third keyframe associated with a left surface of the head;
determining, based at least in part on the first keyframe, one or more first anatomical landmarks associated with the front surface;
determining, based at least in part on the second keyframe, one or more second anatomical landmarks associated with the right surface;
determining, based at least in part on the third keyframe, one or more third anatomical landmarks associated with the left surface; and
wherein the one or more anatomical landmarks includes the one or more first anatomical landmarks, the one or more second anatomical landmarks, and the one or more third anatomical landmarks.

18. The one or more non-transitory computer-readable media of claim 16, wherein localizing the one or more anatomical landmarks with respect to the three-dimensional mesh of the head further comprises for each landmark of the one or more anatomical landmarks:
determining, based at least in part on the two-dimensional image data, a first landmark coordinate and a second landmark coordinate;
determining, based at least in part on the depth data, a third landmark coordinate; and
wherein localizing the one or more anatomical landmarks with respect to the three-dimensional mesh of the head is based at least in part on projecting, based at least in part on the pose data associated with the pose of the user device at the time the depth data and the two-dimensional image data was captured, the landmark onto the three-dimensional mesh.

19. The one or more non-transitory computer-readable media of claim 16, wherein localizing the one or more anatomical landmarks with respect to the three-dimensional mesh of the feature of the body further comprises:
determining, based at least in part on the three-dimensional mesh, two or more semi-landmarks associated with a side profile of the feature;
generating, based at least in part on the one or more semi-landmarks, one or more alignments associated with the three-dimensional mesh;
filtering the one or more alignments, based at least in part on a first anatomical landmark and a second anatomical landmark, to generate one or more second alignments;
determining, for each of the one or more remaining alignments, a distance associated with a third anatomical landmark; and
localizing, based at least in part on the distance, a fourth landmark with respect to the three-dimensional mesh.

20. The one or more non-transitory computer-readable media of claim 16, wherein:
the three-dimensional mesh is a textured three-dimensional mesh,
generating the feature pose further comprises:
generating, based at least in part on the textured three-dimensional mesh and a projection matrix, a two-dimensional surface;
determining, based at least in part on the two-dimensional surface, the feature pose, and
the method further comprises:
determining, based at least in part on the feature pose, a frontal profile image, a left profile image, and a right profile image of the head;
determining, based at least in part on the frontal profile image, the left profile image, and the right profile image of the feature of the body, the one or more anatomical landmarks, and
localizing the one or more anatomical landmarks with respect to the three-dimensional mesh of the head further comprises:
projecting, for each of the one or more anatomical landmarks, a perpendicular straight line from the two-dimensional point associated with a corresponding one of the frontal profile image, the left profile image, and the right profile image into the textured three-dimensional mesh.
